(19) United States
(12) Patent Application Publication
(10) Pub. No.: US 2016/0150917 A1
(43) Pub. Date: Jun. 2, 2016

(54) PIZZA BAG SIDE POCKET

(71) Applicant: Timothy Volke, Clyde, MI (US)

(72) Inventor: Timothy Volke, Clyde, MI (US)

(21) Appl. No.: 14/556,570

(22) Filed: Dec. 1, 2014

(51) Int. Cl. A47J 47/14

(52) U.S. Cl. CPC A47J 47/145

(57) ABSTRACT

A pizza delivery bag with side pockets is provided. The delivery bag includes an inner surface and an outer surface. The inner surface forms a receptacle to receive at least one pizza box. The outer surface may include a first side, a second side, a top portion, a bottom portion, a front end and a rear end. An opening or entrance is formed at the front end. A flap may be attached to the pizza delivery bag in order to open and close the opening. At least one beverage pocket is attached to the outer surface of the pizza delivery bag to secure beverages, or other food items within.

### BACKGROUND OF THE INVENTION

The present invention relates to side pockets and, more particularly, to side pockets attached to pizza bags.

Pizza delivery is a service in which a pizzeria or pizza chain delivers a pizza to a customer. Pizzas may be delivered in pizza boxes or delivery bags, and deliveries are made with an automobile, motor scooter, or bicycle. Delivery jackets that are able to preserve the heat of the pizza are used frequently for transporting the pizza. Sometimes, customers may purchase beverages or sides with their pizza. However, the beverages and sides must be carried separately from the bags, which can be difficult and cumbersome.

As can be seen, there is a need for a bag that is able to carry pizza plus any side orders and drinks.

### SUMMARY OF THE INVENTION

In one aspect of the present invention, an apparatus comprises: a pizza delivery bag comprising an inner surface and an outer surface, wherein the inner surface forms a receptacle to receive at least one pizza box and wherein the outer surface comprises a first side, a second side, a top portion, a bottom portion, a front end and a rear end, wherein an opening is formed at the front end; a flap attached to the pizza delivery bag and operable to open and close the opening; and at least one beverage pocket attached to the outer surface of the pizza delivery bag, wherein the at least one beverage pocket is cylindrical in shape and comprises an opening leading into the pocket.

These and other features, aspects and advantages of the present invention will become better understood with reference to the following drawings, description and claims.

### BRIEF DESCRIPTION OF THE DRAWINGS

FIG. 1 is a perspective view of the present invention shown in use with the straps opened;

FIG. 2 is a top view of the present invention shown in use;

FIG. 3 is a section view taken from 3-3 in FIG. 2;

FIG. 4 is a perspective view of the present invention shown in use with the straps closed;

FIG. 5 is a top view of the present invention shown in use; and

FIG. 6 is a section view taken from 6-6 in FIG. 5

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a bag for delivering pizzas including a bag for securing a food product; and at least one side pocket attached to at least one side of the bag. The present invention may include fabricated pockets that may be affixed/attached to a pizza delivery jacket. The pockets of the present invention may be used to carry drinks, salads, wings, submarine sandwiches and the like. All of the above items may be carried in one jacket, which includes the pockets of the present invention.

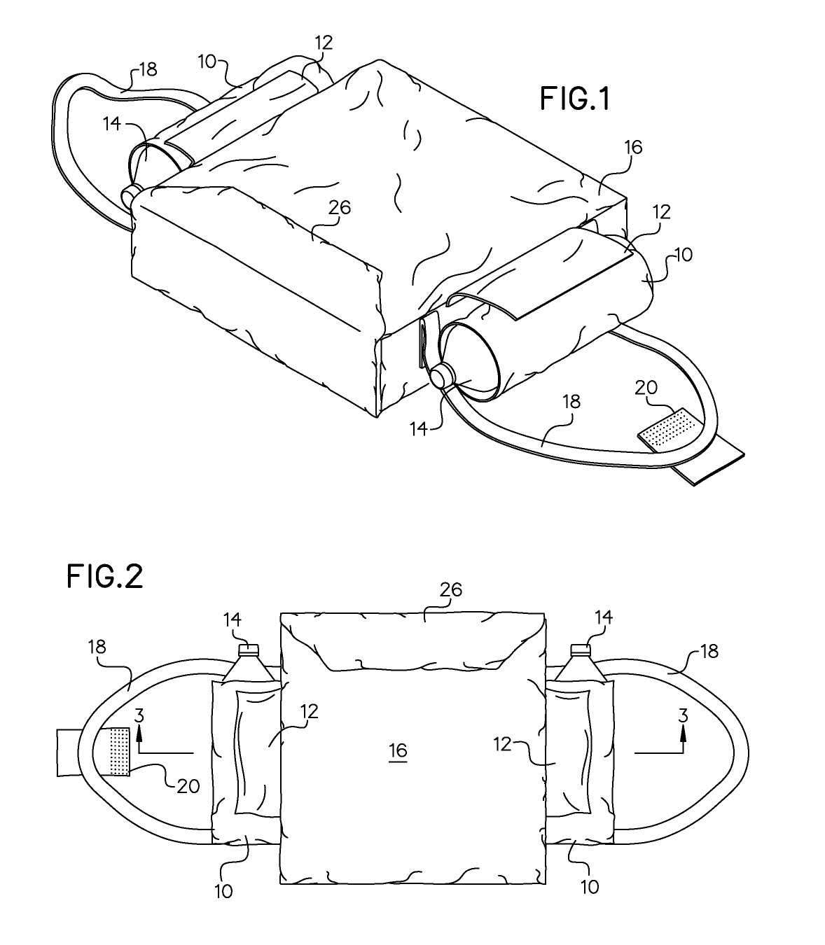

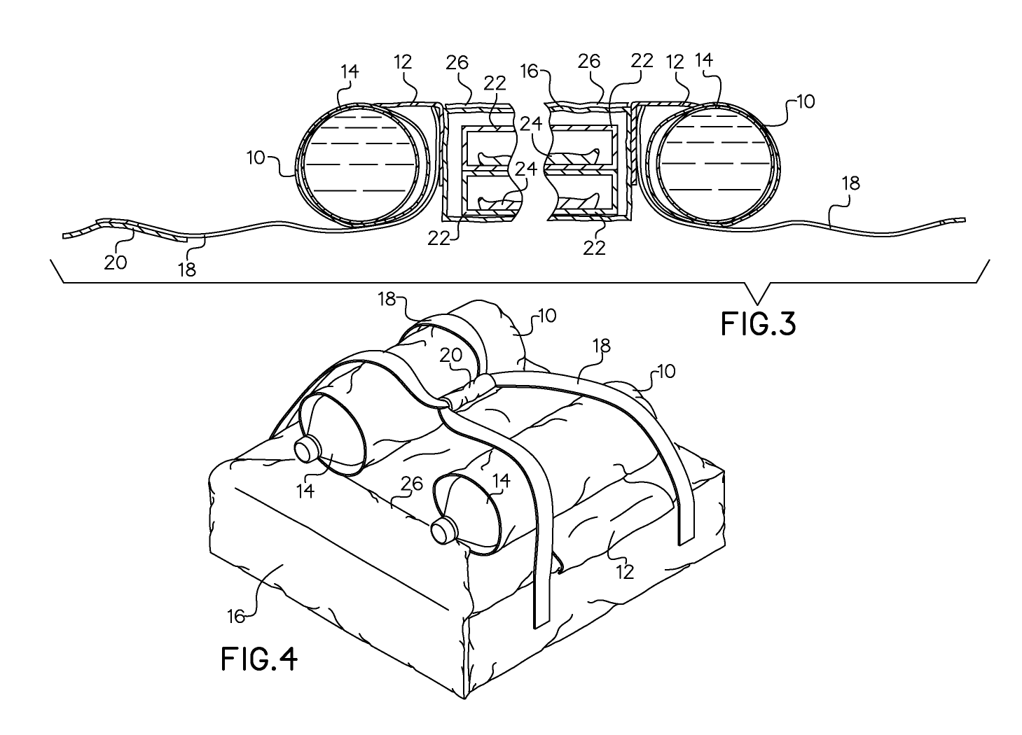

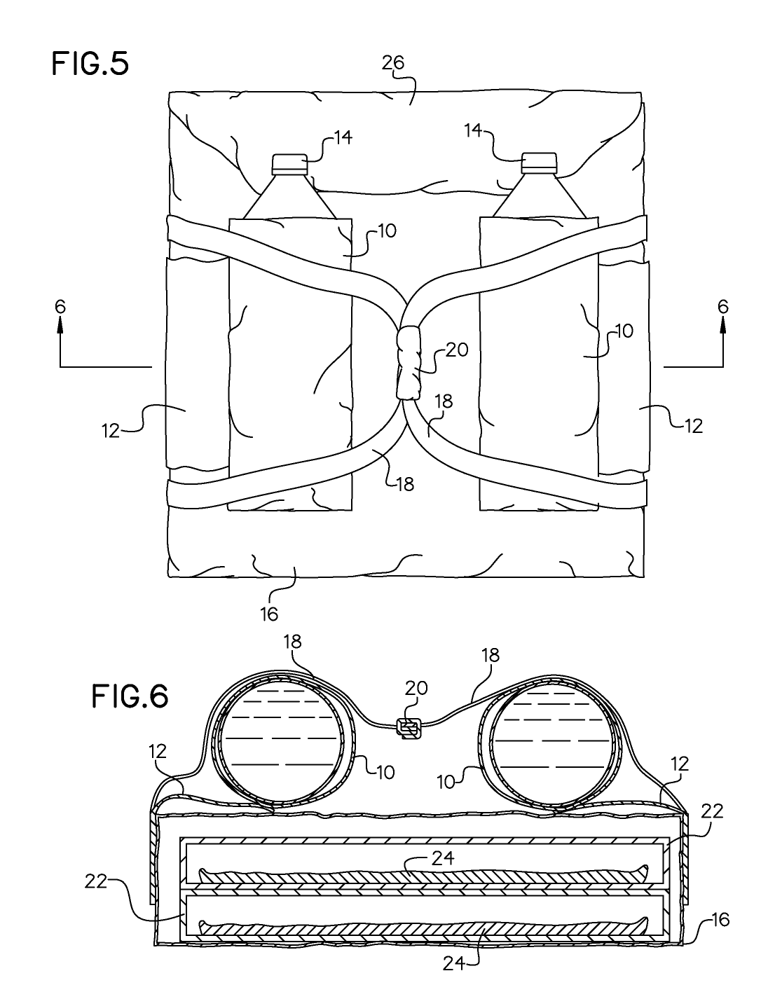

Referring to FIGS. 1 through 6, the present invention includes a pizza delivery bag 16. The pizza delivery bag 16 may be made of an insulating material. The delivery bag 16 may include an inner surface and an outer surface. The inner surface forms a receptacle to receive at least one pizza box 22 having pizza 24 within. The outer surface may include a first side, a second side, a top portion, a bottom portion, a front end and a rear end. An opening or entrance is formed at the front end. A flap 26 may be attached to the pizza delivery bag 16 in order to open and close the opening. At least one beverage pocket 10 is attached to the outer surface of the pizza delivery bag 16 to secure beverages, or other food items within.

The beverage pocket 10 is cylindrical in shape and includes an opening or entrance leading into the pocket 10. In certain embodiments, a first beverage pocket 10 is attached to the first side and a second beverage pocket 10 is attached to the second side. The beverage pocket 10 may be sized to receive a 2-liter beverage bottle 14. The opening of the at least one beverage pocket 10 is facing the same direction as the opening of the pizza delivery bag. Therefore, a user may easily slide pizza 24 and sodas 14 into the bag 16 for convenient carry.

The beverage pockets 10 of the present invention may be foldable. The first beverage pocket 10 is attached to the first side by a first flap 12 and the second beverage pocket 10 is attached to the second side by a second flap 12. The flaps 12 may be long enough so that the beverage pockets 10 may rest to the sides of the pizza bag 16 and then fold over to the top or the bottom of the bag 16 for easy transportation.

The present invention may further include a first handle strap 18 and a second handle strap 18. The first handle strap 18 may be attached to the first side below the first flap 12, and the second handle strap 18 may be attached to the second side below the second flap 12. The first handle strap 18 is releasably attachable to the second handle strap 18. As illustrated in the figures, the first handle strap 18 may include a strap wrap 20 with a hook and loop fastener, or other connector. The strap wrap 20 may wrap around the second handle strap 18 and connect the handles 18 together.

The present invention may include an open position and a closed position as illustrated in FIGS. 1 and 5 respectively. The open position may include the first handle strap 18 and the first beverage pocket 10 oriented on the first side and the second handle strap 18 and the second beverage pocket 10 oriented on the second side. A user may easily load up their pizzas 24 and beverages 14 in the open position. The delivery person may fold the present invention into the close position when they are ready to deliver the food and beverage. The closed position includes the first beverage pocket 10 and the second beverage pocket 10 folded to the top portion and the first handle strap 18 and the second handle strap 18 releasably attached securing the first beverage pocket 10 and the second beverage pocket 10 in between. Therefore the delivery person may easily grasp the strap wrap 20 of the handle 18 and transport the bag 16.

It should be understood, of course, that the foregoing relates to exemplary embodiments of the invention and that modifications may be made without departing from the spirit and scope of the invention as set forth in the following claims.

What is claimed is:

1. An apparatus comprising:
a pizza delivery bag comprising an inner surface and an outer surface, wherein the inner surface forms a receptacle to receive at least one pizza box and wherein the outer surface comprises a first side, a second side, a top portion, a bottom portion, a front end and a rear end, wherein an opening is formed at the front end;
a flap attached to the pizza delivery bag and operable to open and close the opening; and
at least one beverage pocket attached to the outer surface of the pizza delivery bag, wherein the at least one beverage pocket is cylindrical in shape and comprises an opening leading into the pocket.

2. The apparatus of claim 1, wherein the at least one beverage pocket is a first beverage pocket attached to the first side and a second beverage pocket attached to the second side.

3. The apparatus of claim 2, wherein the first beverage pocket is attached to the first side by a first flap and the second beverage pocket is attached to the second side by a second flap.

4. The apparatus of claim 3, further comprising a first handle strap attached to the first side below the first flap, and a second handle strap attached to the second side below the second flap, wherein the first handle strap is releasably attachable to the second handle strap.

5. The apparatus of claim 4, comprising an open position and a closed position, wherein the open position comprises the first handle strap and the first beverage pocket oriented on the first side and the second handle strap and the second beverage pocket oriented on the second side, wherein the close position comprises the first beverage pocket and the second beverage pocket folded to the top portion and the first handle strap and the second handle strap releasably attached over the first beverage pocket and the second beverage pocket.

6. The apparatus of claim 1, wherein the opening of the at least one beverage pocket is facing the same direction as the opening of the pizza delivery bag.

7. The apparatus of claim 1, wherein the pizza delivery bag is made of an insulating material.

8. The apparatus of claim 1, wherein the at least one beverage pocket is sized to receive a 2-liter beverage bottle.
